(19) United States
(12) Patent Application Publication
(10) Pub. No.: US 2026/0321266 A1
(43) Pub. Date: Oct. 15, 2026

(54) SYSTEMS AND METHODS FOR ACHIEVING LOW-LATENCY AND HIGH-RELIABILITY AI VOICE INTERACTION

(71) Applicant: Agora Lab, Inc., Santa Clara, CA (US)

(72) Inventors: Zhen Zhang, Shanghai (CN); Qiankun Li, Shanghai (CN); Qin Wang, Shanghai (CN); Qiming Deng, Shanghai (CN)

(21) Appl. No.: 19/176,308

(22) Filed: Apr. 11, 2025

(51) Int. Cl. G10L 15/30; G10L 15/22

(52) U.S. Cl. CPC G10L 15/30; G10L 15/22

(57) ABSTRACT

Systems and methods for human-to-Artificial Intelligence (AI) interactions with low latency and high reliability are provided. In some cases, an AI client first receives an audio signal from a human. The AI client performs voice detection on the audio signal to identify voice audio data. The encoding frame length may also be adjusted responsive to bandwidth of a network. The audio data is encoded responsive to the encoding frame length, and is transmitted to an AI server. The encoded audio data is buffered in an expanded buffer as compared against traditional communication systems. The AI server may wait for the first of all encoded audio data to be sequentially received or expiration of a maximum wait time to expire before burst decoding the received encoded audio data. The playback strategy may also be adjusted. The decoded audio data may be provided to a large AI model for processing.

### BACKGROUND

The present invention relates in general to the field of audio processing, and more specifically to methods, computer programs and systems for low-latency and high-reliability voice interactions with Artificial Intelligence (AI) systems. The invention specifically relates to a system and method for modulating transmission strategies between a human client system and an AI server system in a manner that improves latency and reliability of the communication system.

In a voice interaction system, often a human is speaking not with another human, but rather with a computer system running one or more AI algorithms for parsing and analyzing human speech. For example, smart speaker systems allow a user to issue commands which are interpreted by the AI system at a remote server, to cause some action to be performed by the computer system. Particularly when the network connection between the human client device and the AI server is less than optimal, latency and reliability are significant concerns to enable accurate and efficient communication between the AI system and the human.

Current systems leverage much of the same communication protocols between the human and the AI system as would be employed in a human-to-human interaction. For example, transmission speeds are uniform and segmented on a consistent basis. This may be optimal for human-to-human interactions, however, may be suboptimal for human-to-AI interactions.

While the above example focuses on a smart speaker device (such as Amazon's Alexa device), the following disclosure is highly applicable to any human voice interaction device, such as the internet of things (IOT), video and audio-conferencing programs, other voice assistants, and the like.

Given that there is great value in having optimal communications between a human and an AI system in order to ensure AI system efficiency and efficacy, as well as a desire for the AI system to provide clear responses to the human, there is a strong desire for improved methods for low latency and high reliability transmissions between a human client and an AI server system.

### SUMMARY

The present systems and methods relate to audio processing, and particularly to low latency and high reliability human to AI interactions. Such systems and methods allow for more accurate processing of the received speech signals by the AI system and greater clarity in the responses by the AI system to the human user.

In some embodiments, the methods and systems for human-to-Artificial Intelligence (AI) interactions with low latency and high reliability are provided. In some cases, an AI client first receives an audio signal from a human. Retransmission rates and Retransmission window may be increased over traditional communication protocol rates, as AI server can handle more retransmission packets in burst. The AI client also performs voice detection on the audio signal to send voice audio data only or set different transport priority on audio packet. The encoding frame length may also be adjusted responsive to bandwidth of a network to balance end-to-end transmission latency and payload ratio

In some embodiments, the encoding frame length increases as the bandwidth decreases. In some specific cases, the encoding frame length varies between approximately 10 ms and approximately 100 ms.

At the AI server, the encoded audio data sent from the AI client is received. The system will only start decoding once the audio data has been completely and sequentially received, ensuring the integrity of the audio. Otherwise, the system will halt decoding, buffer the received audio, and enter the maximum waiting time (max_wait_timeout). Once the waiting time elapses, the system will search the current packet buffer for the next packet to decode. If, during the waiting period, sequentially-arriving packets are received, the decoding process will continue until all the received or buffered audio has been decoded, thereby significantly reducing the end-to-end latency. The decoded audio data can then be sent to a large-scale AI model for processing.

After the AI model processes the human audio data, it may generate a response. This response data from the large AI model is received by the AI server. The AI server may encode every 10 ms the response data in 100 ms chunks. The encoding frame rate may be adjusted from a startup level (e.g., 10 ms) to a stable state rate (e.g., more than 60 ms). The encoded response data may be transmitted from the AI server to the AI client. If an interruption occurs due to AI Server VAD, then the AI server will clear an uplink unencoded buffer and stop transmission.

At the AI client, since the AI server can generate data more quickly, the response data received from the AI server may be cached, and it can withstand greater fluctuations in network quality. The playback strategy has also been adjusted. In traditional communication systems, the receiving side needs to maintain a jitter buffer for tens or even hundreds of milliseconds to counter network jitter. However, for the AI client, due to the fast received data, it can start decoding and playback more quickly within 10 milliseconds without waiting for the jitter buffer period. This significantly reduces the end-to-end latency. The cached response data will be decoded, and the decoded cached response data will be played back at a constant timing that is suitable for human reception. In the event of an interruption, a playback timestamp will be generated and sent back to the AI server, enabling the AI server to know the moment of the interruption and maintain an accurate conversation context.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

In order that the present invention may be more clearly ascertained, some embodiments will now be described, by way of example, with reference to the accompanying drawings, in which:

FIG. 1 is an example illustration of a system for human-to-AI larger model interactions over a network, in accordance with some embodiment;

FIG. 2 is an example block diagram of the client device, in accordance with some embodiment;

FIG. 3 is an example block diagram of the AI server device, in accordance with some embodiment;

FIGS. 4A and 5B are flow diagrams for an example process of human client device operation, in accordance with some embodiments;

FIGS. 5A and 4B are flow diagrams for an example process of AI server device operation, in accordance with some embodiments; and

FIGS. 6A and 6B are illustrations of computer systems capable of implementing the speaker differentiation, in accordance with some embodiments.

### DETAILED DESCRIPTION

The present invention will now be described in detail with reference to several embodiments thereof as illustrated in the accompanying drawings. In the following description, numerous specific details are set forth in order to provide a thorough understanding of embodiments of the present invention. It will be apparent, however, to one skilled in the art, that embodiments may be practiced without some or all of these specific details. In other instances, well known process steps and/or structures have not been described in detail in order to not unnecessarily obscure the present invention. The features and advantages of embodiments may be better understood with reference to the drawings and discussions that follow.

Aspects, features and advantages of exemplary embodiments of the present invention will become better understood with regard to the following description in connection with the accompanying drawing(s). It should be apparent to those skilled in the art that the described embodiments of the present invention provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the present invention as defined herein and equivalents thereto. Hence, use of absolute and/or sequential terms, such as, for example, “will,” “will not,” “shall,” “shall not,” “must,” “must not,” “first,” “initially,” “next,” “subsequently,” “before,” “after,” “lastly,” and “finally,” are not meant to limit the scope of the present invention as the embodiments disclosed herein are merely exemplary.

The present invention relates to systems and methods for low latency and high reliability human to AI interactions. These systems are especially valuable when a user engages with an AI client device that connects to an AI server via the internet. In real-time voice communication, traditionally, the audio collection, transmission, decoding, and playback at the transmitting end are all governed by a fixed clock. Conventionally, this fixed clock is set at intervals of 10 milliseconds. That is, every 10 milliseconds, 10 milliseconds of audio data is transmitted. To guarantee low latency, there is virtually no cache throughout the entire link. At the receiving end, there is only a small jitter buffer to smooth out the delay fluctuations in network transmission. The playback link is also driven by a hardware clock to ensure that the audio data is played at a constant rate. These traditional systems utilize short audio collection intervals, short encoding frame lengths, and small send-receive buffers to ensure low latency. They also adopt uniform-speed decoding and playback to ensure the smoothness of the audio perceived by the human ear. While these traditional technologies are well-suited for human-to-human interactions, they are not optimized for real-time human-to-AI voice interactions. The systems and methods described here offer strong resilience against poor network conditions and ensure high-quality audio while enabling high-performance real-time human-to-AI interactions.

Also note that throughout this disclosure and attending claims, reference will be made to terms such as “approximately”, “roughly” or “about”. These terms have the specific meaning of being plus or minus twenty percent of the listed value. Thus, a timer that is approximately 10 ms in length may vary between 8-12 ms.

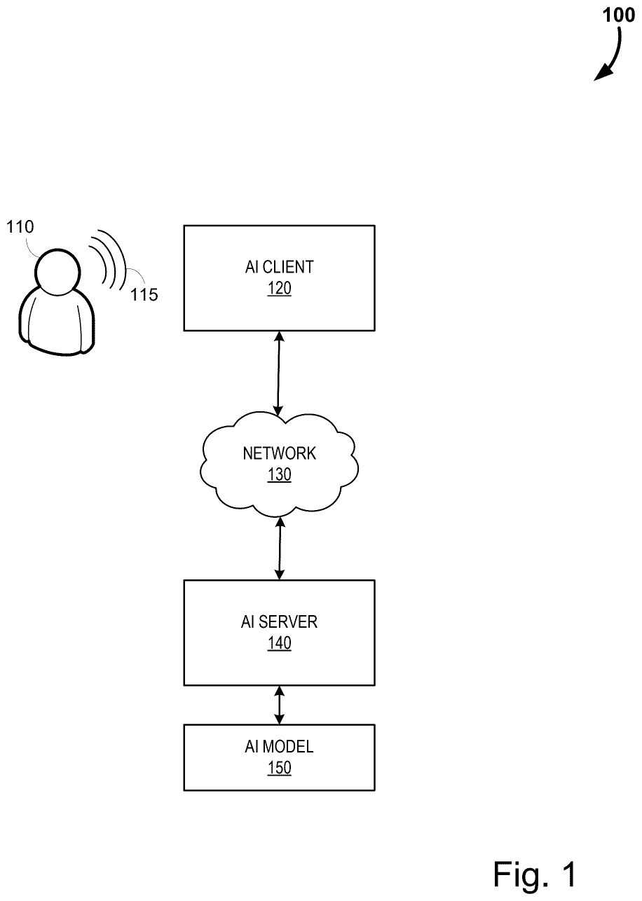

To facilitate discussions, FIG. 1 provides an example illustration of a system that includes a human component 110 generating voice audio communications 115 that are received by an AI client device 120. The AI client device 120 may be a smart phone, smart speaker, computer or an Internet-of-Things (IOT) device (such as a smart doorbell). The AI client couples to a network 130 which allows bilateral communications between the AI client device 120 and an AI server 140 located at an edge location or a network operations center. The AI server operates in concert with a large AI model 150 to process the human generated audio stream and generate a response. The response may be to perform some action (such as turning on a light or switching the temperature on a smart thermostat), generating an audio response, or some combination thereof.

In some embodiments, the AI client 120 has, at a minimum, some sort of microphone or microphone array for collecting the audio 115 from the human and converting it to a digital format for additional processing and transmission. The AI client also includes some local data storage capabilities for data buffering and the like. The AI client 120 also includes some degree of computational resources for pre-processing and encoding the digitized audio signal. The microphone captures these voice signals and converts them into electronic audio signals, and additional audio processing may be performed at the AI client. These audio processing capabilities may include at least acoustic echo cancellation (AEC), adaptive noise suppression (ANS) and automatic gain controller (AGC). The front-end recording may be provided to an AEC module for noise cancellation along with the far-end reference signal (if present) which is what has been played previously via a loudspeaker of the device. The AEC module subtracts out the time delayed far end reference signal from the near end audio signal to remove echo artifacts. The adjusted signal is then provided to a module that analyzes the ambient noise. This ANS module adjusts the signal further to remove ambient noise from the signal. The further adjusted signal is provided to an AGC which is a circuit that is a closed-loop feedback regulating circuit that adjusts the relative amplification of the signal to ensure a consistent volume level. This results in a clean, consistent audio signal that may be well suited for downstream analysis by the AI server for such activities such as voice recognition systems, command word identification algorithms, or for encoding and transmission to other systems.

The network 130 may in many embodiments, be comprised of the internet. In alternate embodiments, the network 130 may be comprised of any of a wide area network (WAN), a local area network (LAN), a cellular network, or some combination thereof.

The AI server 140 may comprise a backend system of one or more computational devices within a datacenter or other network hub. The AI server 140 includes the processing platform for communication with the large AI model 150. The large AI model 150 may be comprised of any suitable AI model for consuming human speech and resolving commands from the voice signals. In some cases, the AI model 150 includes a large language model (LLM). Unlike a human speaker, the AI model 150 has the capability of understanding and processing speech that is played back at different speeds than as spoken by a human. Additionally, unlike a human listener, the AI model 150 is less error tolerant and requires a higher quality voice signal to operate at peak efficiency. Thus, network 130 disruptions or simply poor quality network may significantly impact the effectiveness of the AI model 150 in a human interaction. The present system addresses this by leveraging the fact that the AI understands speech much faster than an human does, therefore removing the restraint that the speech transmission be at a uniform speed. Further, speech may be provided in whole segments. This allows for larger retransmission windows and can allow for a larger cache to be employed to minimize the impact of network transmission packet loss and jitter.

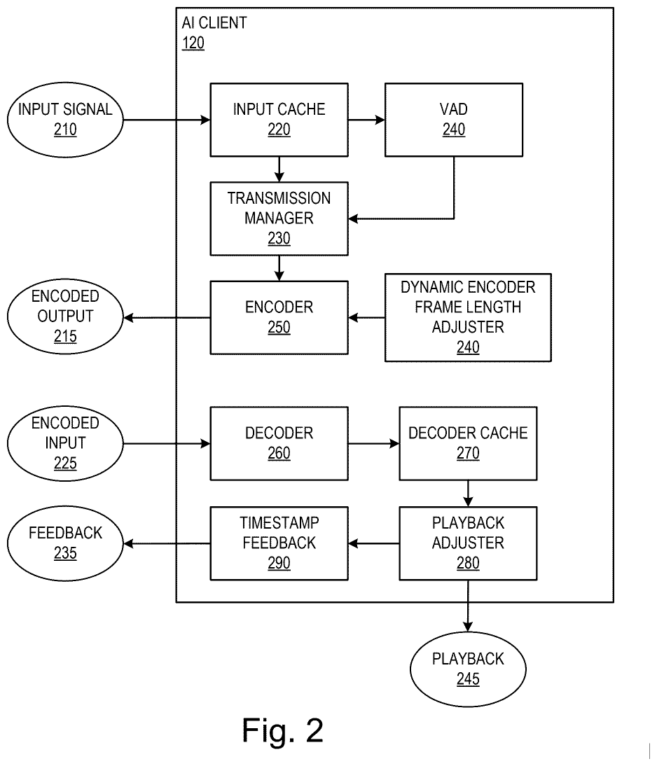

Turning to FIG. 2, a logical block diagram is provided for the AI client 120. This diagram illustrates two logical pathways for the AI client 120, a pathway from the user/human 110 to the AI server 140, and a return pathway from the AI server 140 to the human 110. For the human-to-AI direction, first an input signal 210 is received by the system. It is converted from an acoustic signal to a digital signal, and undergoes pre-processing, including AEC, ANS and AGC, as previously discussed (not illustrated). The resulting clean and gain controlled audio signal is provided to an enlarged input cache 220. The cached audio is processed by a voice activity detection (VAD) system 240 that identifies segments of the audio signal that include voice activity, and those segments devoid of voice activity. For human-to-human interactions, all audio is useful. Spaces in between speech are contextual cues that provide meaning to the user. As such, all audio is transmitted for a human-to-human interaction. In contrast, a human-to-AI system does not require that non-voice audio be transmitted. As such, the VAD information may be utilized to segment out the voice-containing sections of audio, and can ensure that only these audio segments are transmitted, thereby reducing overall transmission bandwidth.

The cached audio data and the voice activity information are all provided to a transmission manager 230 which controls the transmission of data to the AI server. The transmission manager 230 is capable of increasing the number of retransmissions as compared to human-to-human interactions due to the fact that the powerful computing capabilities of the AI server allow it to receive more ‘old’ historical data for quick decoding upon receipt. This allows the number of retransmissions to be increased to enhance the system's ability to resist weak networks. As noted, the retransmission cache is proportionately increased to allow older audio data to be stored. The retransmission window is elongated to increase transmission reliability. And the use of the voice activity information ensures that bandwidth is kept low by ensuring that only audio segments that include voice data are transmitted. “Silent” packets are not sent to reduce bandwidth requirements and to reduce computational resource requirements at the AI server. Lastly, the dynamic encoder frame length adjuster 240 may dynamically adjust the audio encoding frame length (ptime). In situations where the bandwidth is limited the ptime may be adjusted to reduce packet header loads.

The encoder 250 receives the non-silent packets from the transmission manager 230 and the ptime indication from the dynamic encoder frame length adjuster 240, and can encode the packets accordingly and generates the encoded output 215. Additionally, numerous retransmissions of the needed portions of the signal based upon need/network quality may be performed by the AI client.

Once sent to the AI server 140, the human speech may be processed and provided to the large AI model. This will be discussed in greater detail in relation with subsequent figures. However, for now, the AI server will generate an encoded input 225 that is provided back to the AI client 120. The encoded input 225 is then decoded by the decoder 260. The encoded input 225 may include a larger length of speech signal than would normally be generated by another human, as the AI model may generate an entire volume of content in a matter of milliseconds. This information cannot be ‘fast forwarded’ due to the need for a human to consume the content, however, the data may be stored in an increased sized receiving cache 270 buffer to ward against network packet loss. The playback of the decoded signal may be dynamically started once a certain size buffer is accumulated. This buffer size may be responsive to the information loss/reception rate. If more packets are lost in a suboptimal network, the buffer size may be set smaller than if few packets are being lost. This ensures timely playback under normal network conditions and prevents buffering weak network conditions. This dynamic starting of the playback based upon a variable buffer length may be controlled by the playback adjuster 280, which causes the playback 245 to be performed over one or more speakers of the AI client 120. A timestamp feedback module 290 may generate a feedback loop 235 that is a timestamp of the current playback to the AI server 140, which is used by the AI server to know where the AI client is playing, thereby making it easier to align the context of the conversation in the event of an interruption event.

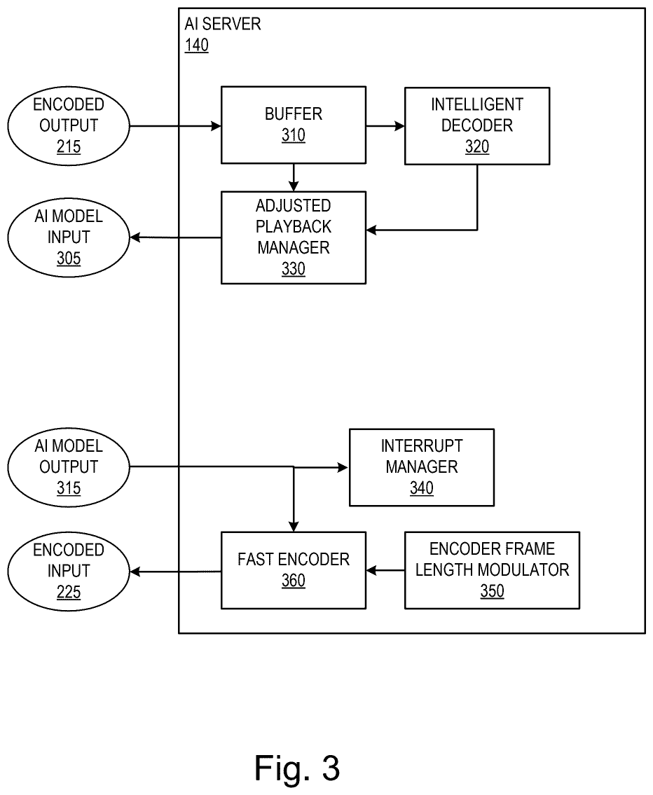

Turning now to FIG. 3, the AI server 140 is illustrated in greater detail. The AI server first receives the encoded output 215 from the AI client 120. This includes receiving retransmissions as required based on the network condition. The encoded output 215 is stored in a buffer 310. The buffer 310 is increased in size as the AI client 120 may retransmit more and ‘older’ data, and thus the AI server 140 needs to allow for a larger receiving buffer. An intelligent decoder 320 adjusts the decoding strategy such that decoding only occurs when complete and sequential audio data is detected. This ensures the integrity of the audio. If the decoder operated as in traditional systems, and decoded the content as received in order to play it back on a consistent timescale, the audio would include defects where data is missing. For a human, the constant audio is preferable, even with faults, than a variable timed, or too fast or too slow playback. This is because humans listening is fault tolerant, and small defects in the audio do not significantly diminish the listening experience. In contrast, the AI model is able to consume the audio very quickly (much faster than any human), and thus having complete audio segments, with pristine quality, is preferable to error prone audio. In some embodiments, the intelligent decoder 320 enters a waiting time for the full sequential data to be received. If the wait time reaches a maximum point without all data being received, the system may force a decoding of the available data, to ensure that the AI model response time is still prompt. During the wait time, if any sequential packets arrive, they may be inserted into the packet set and the decoding can continue.

The decoded data is provided to an adjusted playback manager 330 to generate the AI model input 305. The adjusted playback manager 330 may support fast playback capabilities. In the initial stage, or when there is no audio present, the adjusted playback manager 330 may maintain a fixed timer (the default being approximately 10 ms) to try decoding. Once the decodable audio is found, however, the playback enters the continuous decoding state thus quickly completing a burst audio decoding. The decoded pulse-code modulation (PCM) data is the AI model input 305 that is supplied to the AI model for further processing.

After processing by the AI model, a model output 315 is generated that includes a full corpus of audio. The AI model output 315 may be provided to a fast encoder 360 and a interrupt manager 340. Because the AI large model(s) generate more data, the AI server needs to send the data generated by the larger AI model to the AI client 120 faster, such as every approximately 10 ms to encode and send approximately 100 ms worth of data. An encoder frame length modulator 350 may dynamically increase the ptime in order to save on overhead that is introduced by the packet headers, which improves transmission efficiency. The usage of dynamic ptime encoding, such as using approximately 10 ms ptime in the startup stages and increasing the ptime to larger than approximately 60 ms in the stable stage decreases overall overhead while maintaining transmission quality. The interrupt manager 340 receives feedback in the form of a timestamp if the AI client 120 interrupts the AI server 140. If interrupted during the conversation, the uplink unencoded buffer or the encoding task queue of the AI server is cleared by the interrupt manager 340.

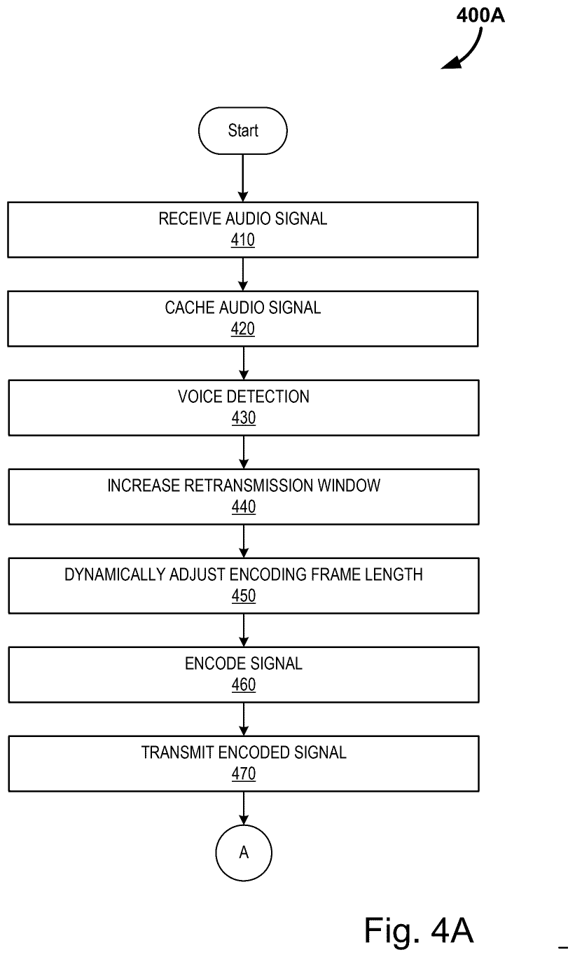

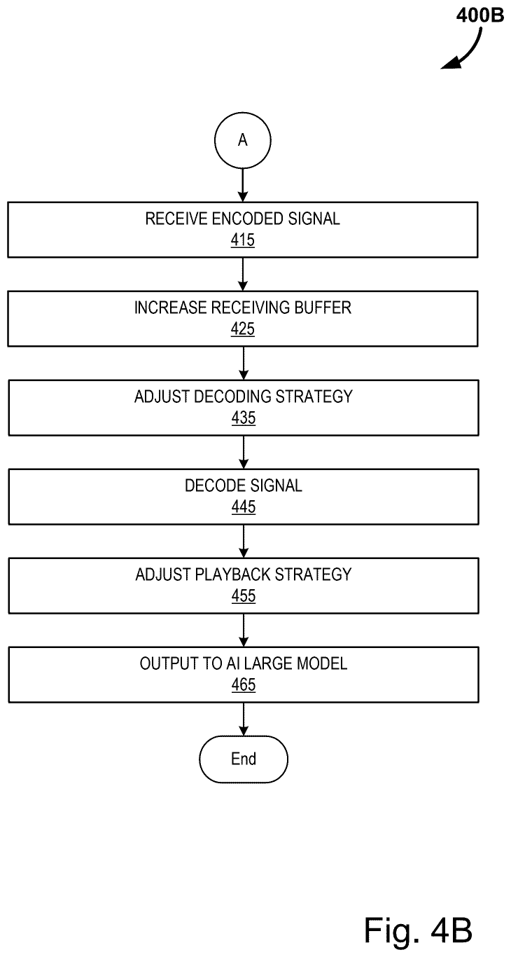

Turning to FIG. 4A the process for human to AI model communication is provided from the perspective of the user/human generating an audio signal by speaking, and the AI client device receiving the audio signal (at 410) and converting the acoustic audio to a PCM data signal. This data signal is cached (at 420) in an enlarged cache storage as compared against traditional communication systems. The system performs a series of audio preprocessing techniques that may be employed to ensure the audio signal is a clean signal, including activities such as noise and echo cancellation, as well as gain control (no illustrated).

The cleaned audio signal is processed for voice detection (at 430) at the AI client device. Only portions of the audio signal that includes voice content are transmitted by the AI client to the AI server to improve overall bandwidth requirements. The retransmission window is increased over what is traditionally employed for human voice interactions (at 440). Further, the encoding frame length is dynamically adjusted (at 450) responsive to bandwidth constraints. When bandwidth is more limited, the ptime may be increased to longer time periods (e.g., approximately 60 ms or more) in order to reduce header overhead.

The signal is encoded for transmission (at 460) and is transmitted to the AI server (at 470). The system is able to retransmit the data a greater number of times in a longer retransmission window based upon the ability of the AI system to consume the data very quickly. The process is continued in relation to FIG. 4B, where at the AI server the encoded signal is received (at 415). The AI server has an increased receiving buffer (at 425) such that complete interactions may be cached for the AI model to consume. The decoding strategy may also be adjusted (at 435) such that decoding waits, up to a preconfigured maximum wait time, for the complete sequential audio data to be received. Only once the complete audio data is received, or upon passage of the maximum wait time, is the decoding started. If the maximum wait time passes without the complete set of audio data being received, the decoding will begin, and any received data will be sequentially inserted into the decoded data stream. The signal is thus decoded (at 445) and the playback strategy for the AI model is adjusted (at 455). The adjusted playback supports rapid playback-much faster than would be comprehensible by a human, but which can be consumed readily by the AI model. The playback maintains a fixed timer before there is audio present. In some embodiments, a timer of approximately 10 ms is employed. However, once there is data to decode and playback, the system enters a continuous decoding state, resulting in a quick and complete burst audio decoding. The decoded data is then provided to the large AI model for processing (at 465).

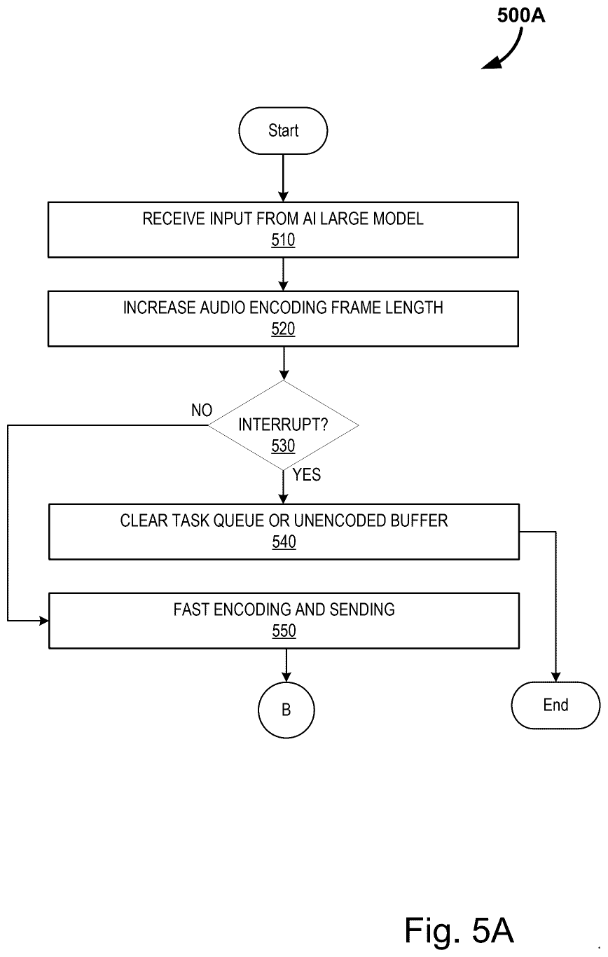

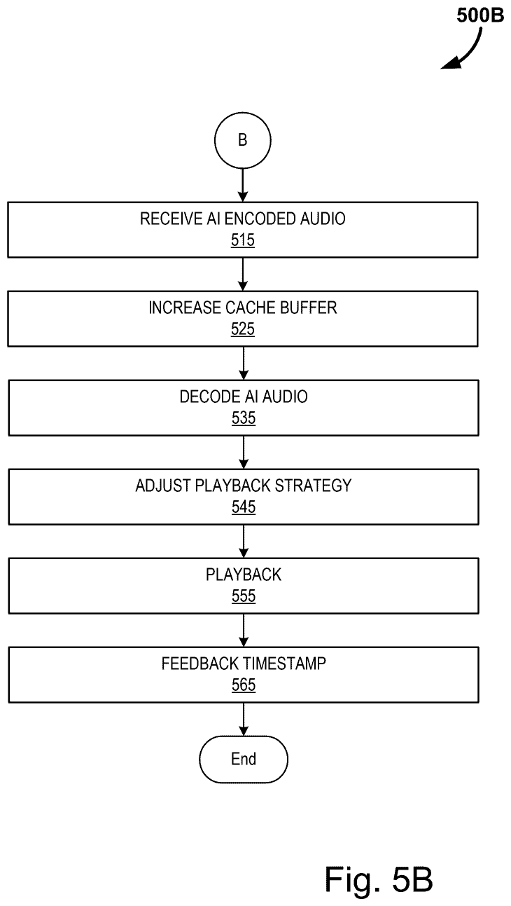

The AI model consumes the human communication and determines what actions to take, and generally outputs a return audio signal for the human to consume. FIG. 5A begins with the AI server receiving input from the AI large model (at 510). This data is provided as a single data stream all at once (or over a very short period of time) as the processing speed of the AI model is much faster than the speaking speed of a human. The audio encoding frame length may be increased from once transmitting at a stable rate in order to minimize header overhead (at 520) and thereby improve transmission efficiency. In some cases, bandwidth considerations impact the encoding frame length, with reduced bandwidth correlating with longer frame length. While encoding, the system may receive an interruption from the AI client (at 530). If an interruption occurs, the task queue or unencoded buffer are cleared (at 540), thus terminating the process. However, if no interruption is received, the process undergoes fast encoding and sending (at 550). In some embodiments, every approximately 10 ms the system may encode and send what is approximately 100 ms of audio playback data.

The process continues at FIG. 5B where the sent audio data is received by the AI client (at 515). As larger segments of audio data are being transmitted by the AI server to the AI client, a larger cache buffer needs to be employed (at 525) in order to store all the relevant data. The AI audio data is decoded (at 535) and the playback strategy is adjusted (at 545). In some embodiments, the buffer accumulation may be dependent on packet loss rate. In some embodiments, the initiation of decoding may depend on the initial received bitrate. Under normal circumstances, the received rate is much higher than the playback rate, which can reduce the decoding and playback waiting time. If the received rate is lower than expected the waiting time for playback will be appropriately increased. This ensures timely playback under normal network conditions and prevents buffering under poor network conditions. The audio is then played back for the user (at 555), and a feedback timestamp is generated and provided back to the AI server (at 565) ensuring the AI server knows where in the playback the process was in the event of an interruption. Knowing the timing in the playback when an interruption occurs can be helpful in generating contextual information regarding the interruption. After playback concludes, the process ends.

The above-described methods and systems for low latency and high reliability human-to-AI interactions are able to maintain the audio sent to AI integrity during sending and receiving. The audio sent to the human also has improved latency and better audio quality. The system performs better than traditional fixed timing communication systems when exposed to network jitter, network packet loss and even network disconnections. Interruptions are also improved, and response delay are shortened with the presently disclosed systems and methods. Response delay, interruption delay and answer quality are hallmarks of quality conversations between humans and AI systems. Thus, the perceived conversation experience is improved by implementing the presently disclosed systems and methods.

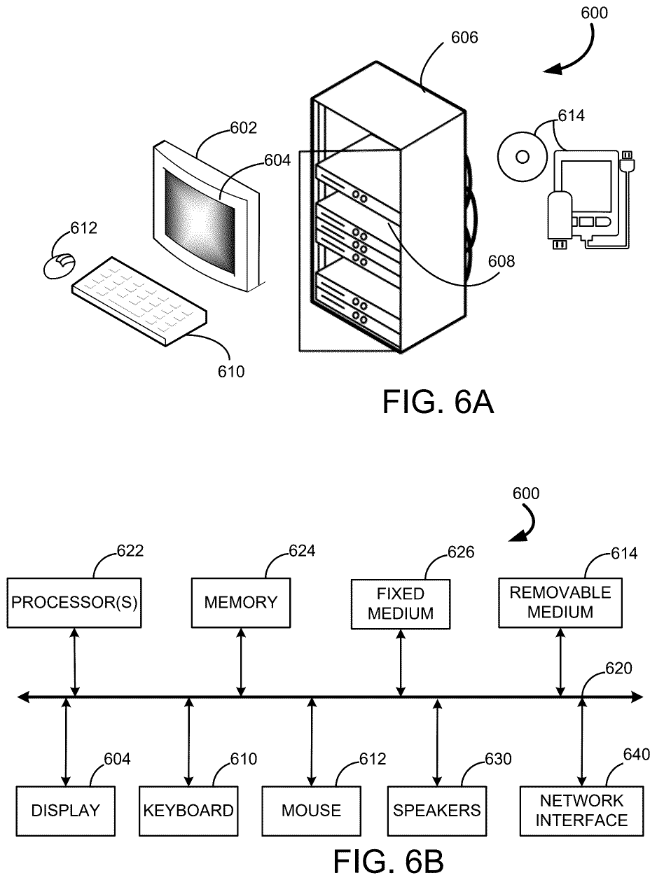

Now that the systems and methods for improved human-to-AI communications have been provided, attention shall now be focused upon apparatuses capable of executing the above functions in real-time. To facilitate this discussion, FIGS. 6A and 6B illustrate a Computer System 600, which is suitable for implementing embodiments of the present invention. FIG. 6A shows one possible physical form of the Computer System 600. Of course, the Computer System 600 may have many physical forms ranging from a printed circuit board, an integrated circuit, and a small handheld device up to a huge supercomputer. Computer system 600 may include a Monitor 602, a Display 604, a Housing 606, server blades including one or more storage Drives 608, a Keyboard 610, and a Mouse 612. Medium 614 is a computer-readable medium used to transfer data to and from Computer System 600. FIG. 6B is an example of a block diagram for Computer System 600. Attached to System Bus 620 are a wide variety of subsystems. Processor(s) 622 (also referred to as central processing units, or CPUs) are coupled to storage devices, including Memory 624. Memory 624 includes random access memory (RAM) and read-only memory (ROM). As is well known in the art, ROM acts to transfer data and instructions uni-directionally to the CPU and RAM is used typically to transfer data and instructions in a bi-directional manner. Both of these types of memories may include any suitable form of the computer-readable media described below. A Fixed Medium 626 may also be coupled bi-directionally to the Processor 622; it provides additional data storage capacity and may also include any of the computer-readable media described below. Fixed Medium 626 may be used to store programs, data, and the like and is typically a secondary storage medium (such as a hard disk) that is slower than primary storage. It will be appreciated that the information retained within Fixed Medium 626 may, in appropriate cases, be incorporated in standard fashion as virtual memory in Memory 624. Removable Medium 614 may take the form of any of the computer-readable media described below.

Processor 622 is also coupled to a variety of input/output devices, such as Display 604, Keyboard 610, Mouse 612 and Speakers 630. In general, an input/output device may be any of: video displays, track balls, mice, keyboards, microphones, touch-sensitive displays, transducer card readers, magnetic or paper tape readers, tablets, styluses, voice or handwriting recognizers, biometrics readers, motion sensors, brain wave readers, or other computers. Processor 622 optionally may be coupled to another computer or telecommunications network using Network Interface 640. With such a Network Interface 640, it is contemplated that the Processor 622 might receive information from the network, or might output information to the network in the course of performing the above-described human-to-AI interaction methods. Furthermore, method embodiments of the present invention may execute solely upon Processor 622 or may execute over a network such as the Internet in conjunction with a remote CPU that shares a portion of the processing.

Software is typically stored in the non-volatile memory and/or the drive unit. Indeed, for large programs, it may not even be possible to store the entire program in the memory. Nevertheless, it should be understood that for software to run, if necessary, it is moved to a computer readable location appropriate for processing, and for illustrative purposes, that location is referred to as the memory in this disclosure. Even when software is moved to the memory for execution, the processor will typically make use of hardware registers to store values associated with the software, and local cache that, ideally, serves to speed up execution. As used herein, a software program is assumed to be stored at any known or convenient location (from non-volatile storage to hardware registers) when the software program is referred to as “implemented in a computer-readable medium.” A processor is considered to be “configured to execute a program” when at least one value associated with the program is stored in a register readable by the processor.

In operation, the computer system 600 can be controlled by operating system software that includes a file management system, such as a medium operating system. One example of operating system software with associated file management system software is the family of operating systems known as Windows® from Microsoft Corporation of Redmond, Washington, and their associated file management systems. Another example of operating system software with its associated file management system software is the Linux operating system and its associated file management system. The file management system is typically stored in the non-volatile memory and/or drive unit and causes the processor to execute the various acts required by the operating system to input and output data and to store data in the memory, including storing files on the non-volatile memory and/or drive unit.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is, here and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

The algorithms and displays presented herein are not inherently related to any particular computer or other apparatus. Various general-purpose systems may be used with programs in accordance with the teachings herein, or it may prove convenient to construct more specialized apparatus to perform the methods of some embodiments. The required structure for a variety of these systems will appear from the description below. In addition, the techniques are not described with reference to any particular programming language, and various embodiments may, thus, be implemented using a variety of programming languages.

In alternative embodiments, the machine operates as a standalone device or may be connected (e.g., networked) to other machines. In a networked deployment, the machine may operate in the capacity of a server or a client machine in a client-server network environment or as a peer machine in a peer-to-peer (or distributed) network environment.

The machine may be a server computer, a client computer, a personal computer (PC), a tablet PC, a laptop computer, a set-top box (STB), a personal digital assistant (PDA), a cellular telephone, an iPhone, a Blackberry, Glasses with a processor, Headphones with a processor, Virtual Reality devices, a processor, distributed processors working together, a telephone, a web appliance, a network router, switch or bridge, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies of the presently disclosed technique and innovation.

In general, the routines executed to implement the embodiments of the disclosure may be implemented as part of an operating system or a specific application, component, program, object, module or sequence of instructions referred to as “computer programs.” The computer programs typically comprise one or more instructions set at various times in various memory and storage devices in a computer (or distributed across computers), and when read and executed by one or more processing units or processors in a computer (or across computers), cause the computer(s) to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution

While this invention has been described in terms of several embodiments, there are alterations, modifications, permutations, and substitute equivalents, which fall within the scope of this invention. Although sub-section titles have been provided to aid in the description of the invention, these titles are merely illustrative and are not intended to limit the scope of the present invention. It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

What is claimed is:

1. A computerized method for human-to-Artificial Intelligence (AI) interactions with low latency and high reliability, the method comprising:
receiving an audio signal from a human;
performing voice detection on the audio signal to identify voice audio signals;
increase a retransmission cache to include sufficient storage to retain at least approximately 2 seconds of audio recording;
dynamically adjust encoding frame length responsive to bandwidth of a network;
encode the audio signals responsive to the encoding frame length; and
transmit repeatedly the encoded audio signals a minimum of approximately 10 times.

2. The method of claim 1, wherein the encoding frame length increases as the bandwidth decreases.

3. The method of claim 2, wherein the encoding frame length varies between approximately 10ms and approximately 100 ms.

4. The method of claim 1, wherein the transmitting is to an AI server over the network.

5. The method of claim 4, further comprising receiving at least approximately 100 ms of audio data from the AI server every approximately 10 ms.

6. The method of claim 5, further comprising:
dynamically buffering the audio data received from the AI server responsive to network conditions such that the buffer length is inversely proportional to network quality;
decoding the buffered audio data;
playing back the decoded buffered audio data at a constant timing suitable for human consumption;
generating a timestamp of the playing back; and
transmitting the timestamp as feedback to the AI server.

7. A computerized method for human-to-Artificial Intelligence (AI) interactions with low latency and high reliability, the method comprising:
at an AI server receiving encoded audio data from an AI client;
start decoding once the encoded audio data has been completely and sequentially received, ensuring the integrity of the audio;
the AI server halts decoding, buffers the received audio, and enter the maximum waiting time (max_wait_timeout)
once the maximum waiting time elapses, the AI server searches the current packet buffer for the next packet to decode;
when sequentially arriving packets are received, the decoding process continues until all the received or buffered audio has been decoded; and
providing the decoded audio data to a large AI model for processing.

8. The method of claim 1, wherein the fixed timer is set to approximately 10 ms.

9. The method of claim 2, wherein the maximum wait time is set to approximately 2000 ms.

10. The method of claim 5, further comprising:
receiving response data from the large AI model;
every Xms encode and send Yms of the response data to the AI client, wherein X is smaller than Y; and
increase encoding frame rate of a startup rate to a stable state, wherein the startup rate is less than the stable rate.

11. The method of claim 10, wherein the maximum X is approximately 10 and Y is approximately 100.

12. The method of claim 10, wherein the startup rate is approximately 10 ms and the stable rate is greater than approximately 60 ms.

13. The method of claim 10, further comprising receiving an interruption from the AI client and clearing an uplink unencoded buffer or clearing an encoding task queue of the AI server.

14. A computerized method for human-to-Artificial Intelligence (AI) interactions with low latency and high reliability, the method comprising:
at an AI server receiving encoded audio data from an AI client;
buffering the encoded audio data;
wait for the first of all encoded audio data to be sequentially received or expiration of a maximum wait time to expire before burst decoding the received encoded audio;
adjust playback strategy to maintain a fixed timer to attempt to decode the received encoded audio data before the audio data is detected and after the audio data is detected continuously decoding the encoded audio data;
providing the decoded audio data to a large AI model for processing;
receiving response data from the large AI model;
every Xms encode and send Yms of the response data to the AI client, wherein X is smaller than Y;
increase encoding frame rate of a startup rate to a stable state, wherein the startup rate is less than the stable rate; and
transmitting the encoded response data to the AI client.

15. The method of claim 14, further comprising:
dynamically buffering the encoded response data received from the AI server responsive to network conditions such that the buffer length is inversely proportional to network quality;
decoding the buffered response data;
playing back the decoded buffered response data at a constant timing suitable for human consumption;
generating a timestamp of the playing back; and
transmitting the timestamp as feedback to the AI server.

16. The method of claim 14, further comprising:
receiving the audio signals from a human;
caching the audio signals;
performing voice detection on the audio signals to identify the audio data;
dynamically adjusting encoding frame length responsive to bandwidth of a network;
encode the audio data responsive to the encoding frame length; and
transmit the encoded audio data.
